SEQUENCE LISTING (20 sequences)

SEQ ID NO: 1 - DNA, 36 bp, Artificial
  Probe sequence
agcacagggtactttattgatggtacatgacaaggt

SEQ ID NO: 2 - DNA, 44 bp, Artificial
  Probe sequence
cctcaaggaagcccacacagaacatgttgytggtaatctttcca

SEQ ID NO: 3 - DNA, 25 bp, Artificial
  Probe sequence
accacacgggtctggtatttatgct

SEQ ID NO: 4 - DNA, 44 bp, Artificial
  PCR primer
ctaatacgactcactatagggagaatgaaaaaattgatgatggt

SEQ ID NO: 5 - DNA, 45 bp, Artificial
  PCR Primer
tttttttttttttttttttttttttcagagtgcgattgatttggc

SEQ ID NO: 6 - DNA, 29 bp, Artificial
  Probe sequence
gtatctatattcatcataggaaacaccaa

SEQ ID NO: 7 - DNA, 14 bp, Artificial
  Partial sequence from CFTR gene containing ?F508 region
tcatctttggtgtt

SEQ ID NO: 8 - DNA, 11 bp, Artificial
  Partial sequence from CFTR gene containing ?F508 region
tcattggtgtt

SEQ ID NO: 9 - DNA, 33 bp, Artificial
  Probe sequence
taccctctgaaggctccagttctcccataatca

SEQ ID NO: 10 - DNA, 12 bp, Artificial
  Partial sequence from CFTR gene containing 1540A
taatgatgatta

SEQ ID NO: 11 - DNA, 12 bp, Artificial
  Partial sequence from CFTR gene containing 1540G
taatggtgatta

SEQ ID NO: 12 - DNA, 37 bp, Artificial
  Probe sequence
gagaggctgtactgctttggtgacttcccctaaatat

SEQ ID NO: 13 - DNA, 26 bp, Artificial
  Partial sequence from 394delTT region of CFTR gene
tctttttatatttaggggaagtcacc

SEQ ID NO: 14 - DNA, 24 bp, Artificial
  Partial sequence from CFTR gene with 394delTT
tctttatatttaggggaagtcacc

SEQ ID NO: 15 - DNA, 43 bp, Artificial
  Probe sequence
attcttgctcgttgacctccactcagtgtgattccaccttctc

SEQ ID NO: 16 - DNA, 17 bp, Artificial
  Partial sequence from G653X region of CFTR gene
ttcttggagaaggtgga

SEQ ID NO: 17 - DNA, 17 bp, Artificial
  Partial sequence G542X mutation from CFTR gene
ttctttgagaaggtgga

SEQ ID NO: 18 - DNA, 47 bp, Artificial
  Probe sequence
gcaactttccatatttcttgatcactccactgttcatagggatccaa

SEQ ID NO: 19 - DNA, 15 bp, Artificial
  Partial sequence from CFTR gene N1303K mutation region
gaaaaaacttggatc

SEQ ID NO: 20 - DNA, 15 bp, Artificial
  Partial sequence from CFTR gene N1303K mutation region
gaaaaaagttggatc

(19) United States
(12) Patent Application Publication
(10) Pub. No.: US 2009/0011944 A1
(43) Pub. Date: Jan. 8, 2009

(54) METHOD AND TEST KIT FOR DETECTING NUCLEOTIDE VARIATIONS

(75) Inventors: Hans SODERLUND, Espoo (FI); Jari Raitio, Espoo (FI)

Correspondence Address: ARENT FOX LLP, 1050 CONNECTICUT AVENUE, N.W., SUITE 400, WASHINGTON, DC, 20036, US

(73) Assignee: VALTION TEKNILLINEN TUTKIMUSKEKUS, Espoo (FI)

(21) Appl. No.: 12/034,145

(22) Filed: Feb. 20, 2008

Related U.S. Application Data
(60) Provisional application No. 60/902,361, filed on Feb. 21, 2007.

(51) Int. Cl. C40B 20/04

(52) U.S. Cl. 506/4

(57) ABSTRACT

The present invention is related to a method for a simultaneous determination of the relative amounts of more than one target polynucleotide sequence and nucleotide variations in said targets. The method is carried out by separating and recording single-stranded probes, which have hybridized to the targets and which are determined and distinguished by their defined properties including size and optional detectable label. The probes are complementary to a region in the target that has a sequence being contiguous to the nucleotide variations to be determined. After being hybridized with affinity-tagged targets, the probes are attached to a solid support and purified. The target probe hybrids are elongated using enzyme-assisted elongations. The elongated probes are recorded after release from the solid supports and the amount of each of the targets and their nucleotide variations and the ratio of modified and modified target polynucleotide sequences are calculated from the recorded results. Also disclosed is a test kit, which kit comprises in a packaged form devices equipments and reagents as well as instructions for carrying out the method. The method is useful for several diagnostic purposes.

### TECHNICAL FIELD OF INVENTION

The present invention is related to a method, which enables simultaneous determination, directly from a sample solution, which may be a cell or tissue lysate, of the amounts of a plurality of target polynucleotide sequences and nucleotide variations therein using affinity-aided solution hybridization with a plurality of detector probes and enzyme-assisted elongation of said detector probes. The invention also discloses a test kit comprising in a packaged form, devices with pools comprising a mixture of detector probes with defined properties and reagents as well as instructions for carrying out the method. Uses of said method and test kit for various diagnostic purposes are disclosed.

### BACKGROUND OF INVENTION

As a response to the rapid increase in available genetic information and its impact on molecular biology, health care, treatment modalities, pharmaceutical research, epidemiological studies, etc., the scientific interest is today focusing on the cellular effects of the genetic key elements as well as their biological role and functions. While the accumulation of new information related to the basic key elements in genetics is slowing down, the desire to study the biological role of genes, their expression products and factors having an effect on the expression as well as the impact of expressed genes on sickness and health, is steadily increasing.

Bioinformatics, dealing with information related to life processes and accumulating in biosciences should be in a form that may be computerized and handled in a numerically exact manner. Rapid assessment of the effects and potential importance of various external stimuli on the expression of various target polynucleotide sequences and their nucleotide variations are desirable in bioinformatics. This has created a tremendous demand for new tools allowing rapid, accurate and preferably quantitative assessment of the effects and biological role, not only of target polynucleotide sequences, but also nucleotide variations therein, including point mutations, nucleotide variations, single nucleotide polymorphism, and the like. The impact of these nucleotide variations and their expression in various cells and tissues is a desirable object when diagnosing disposition to and causes or treatment modalities of various diseases and disorders. A significant market has grown up around the technology, but still it is desirable to develop new methods providing a more versatile and quantitative profiling. Transcriptional profiles are not only used by scientists in many areas of basic research in life sciences, but transcriptional profiling is also frequently employed in industrial research and development. The effects of known and novel drugs on the gene expression of human beings and experimental animals is today an essential knowledge in the pharmaceutical and diagnostic industry as well as in health care including hospitals and health centers, but beneficiaries will also be several other sectors of the biotechnology industry, including food industry, agriculture and forestry.

A powerful tool in transcriptional profiling is the oligomer-chip technology, which enables the simultaneous detection of a multitude of target polynucleotide sequences. Due to the insufficient discriminatory power of the micro-arrays, primarily caused by background noise, it is often impossible to compare results with sufficient accuracy to obtain quantitative results.

While the hybridization technology represented by micro-array system has developed tremendously, new uses for the technology has also been created. These new uses, including translation of genomics or expressed genomics into therapy, have created a need for more accurate methods providing repeatable quantitative results. Today it is known that hereditary factors are the cause of a multitude of diseases including vascular diseases, cancer, obesity, etc. The outbreak of these diseases is not only dependent of hereditary, genomic factors, but also of the expression of the genes, and many factors regulating the genes and the degree of their expression. Therefore, methods needed when translating genomics to therapy must be quantitative and enable the determination of changes in expression levels, but simultaneously the method, in addition to being robust and repeatable and applicable for handling a multitude of samples, should be easy to perform. Some of these problems have been challenged by developing more effective micro-array systems, but the problems have also been tackled by replacing the solid phase hybridization-based micro-arrays with solution hybridization methods, which are performed in a liquid phase and combines solution hybridization with a solid phase adsorption-desorption reaction.

Such quantitative and sensitive methods for determining the amount of target polynucleotide sequences are described in the U.S. patent applications having the publication numbers US 20040053300 and US 20060035228. A multiplexed method for transcript analysis is described in Kataja et al., 2006, J. Microbiol. Methods, 67: 102-113. The multiplexity of the method is obtained by using detector probes with distinct sizes, separable by capillary electrophoresis. However, these methods do not describe how to quantify nucleotide variations, which are important when translating genomic and expressed genomics to therapy.

In one of the first methods developed for determining nucleotide variations in target polynucleotide sequences, only nucleotide variations in genomic DNA, were assayed. One of these methods, the so called minisequencing method is disclosed in the U.S. patent applications having the publication numbers US 20030082530 and US 20030082531. The U.S. Patent Application US 200300129589 provides a method for DNA sequencing, detecting mutations and other diagnostic markers using mass spectrometry. The presence or absence of multiple nucleic acid sequences in a polynucleotide sample by using probe ligation is disclosed in the U.S. Pat. No. 5,514,543. The methods disclosed in the U.S. Patent Applications US 200500214825 and US 200400121342, and in the International Patent Applications WO 02/33126 and WO 2004/063700 describe methods for detecting multiple polynucleotide sequences in a sample. The Arrayed Primer Extension (APEX) method disclosed in Pirrung et al., 2001, Bioorg. Med. Chem. Lett., 11: 2437-2440 was developed for RNA analysis and involves a solid-phase, single nucleotide primer extension of DNA/RNA hybrids by reverse transcriptases.

None of the methods mentioned above enable the simultaneous analysis and determination of the amounts of a plurality of target polynucleotide sequences and a nucleotide variation in each of the said target sequences. Thereby, none of the methods allow a quantitative determination of the relative amounts of target polynucleotide sequences and nucleotide variations therein and does not allow the determination of the ratio between the amount of modified genes and the amount of unmodified genes and particularly none of said methods allows the determination of the level of expressed genes and variations therein. However, as evident from the discussion above it is of outmost importance in modern medicine to obtain accurate results when making a diagnosis, predicting the treatment response and deciding what treatment modalities are most effective and most suitable for the patient.

### SUMMARY OF THE INVENTION

The objective of the present invention is to provide methods and test kits to be used in said methods, particularly for obtaining accurate results when making a diagnosis, predicting a treatment response or selecting the most effective treatment modalities. The present invention discloses a method for the simultaneous determination from a sample comprising a multitude of polynucleotide sequences, the amounts of a plurality target polynucleotide sequences and nucleotide variations present in said target sequences. Therefore, the objective of the present invention is not only the determination of nucleotide variations in a defined gene, but the simultaneous determination of the proportion of those targets which have a nucleotide variation or those which do not have it. A target does not necessarily represent a gene, but one or more of the targets may together represent a gene with many nucleotide variations. Furthermore the proportions of nucleotide variations present in RNA sequences representing the expressed gene products, may be determined in an earlier stage than that obtained by detecting the presence or absence of expressed peptides or proteins, including enzymes. The present invention provides a method for determining more versatile expression patterns or transcriptional profiles of target polynucleotide sequences (targets) and nucleotide variations therein by their simultaneous determination from the same sample solution. At the same time a very sensitive and robust and repeatable test is provided, which in addition to the determination of the amounts of a plurality of targets, allows the simultaneous determination of the amounts of at least one nucleotide variation in each of said targets. All this can be determined, without isolating the polynucleotide sequences, from the water-based sample solution, e.g. the cell or tissue lysate, which may comprise a plurality of targets among a mixture of polynucleotide sequences.

The present method allows specific and sensitive diagnosing of hereditary diseases, or hereditary disposition to certain diseases, and particularly it provides information about expression phenomena and the presence of nucleotide variations in expression products. This provides a totally new dimension in the prediction of the progress and development of hereditary diseases and efficacy of treatments.

Accordingly, an advantage of the methods and test kits used in the present invention is that it allows not only the assessment of nucleotide variations in genomic DNA, but also allows simultaneous assessment of transcriptional profiles or expression patterns and nucleotide variations created during expression. These results have a great impact on the diagnostic conclusions made by practitioners in medicine and health care, particularly when making a prognosis of the development of the disease and evaluating the efficacy of a medical treatment.

A particular advantage of the present invention is that the quality of the targets in the preparation to be analyzed is not critical. RNA, which is known to require special treatment due to its instability, including use of RNAse inhibitors, may be used directly in the test without converting the RNA to cDNA. In the present method, the procedure may be interrupted after the hybridization step, and the samples comprising affinity-tagged targets, such as mRNA target and DNA, including the target-detector probe-hybrids or -complexes, which through the affinity-tagged targets are captured on or attached to solid supports, may be stored until all samples for a comparative test are collected and are ready for a simultaneous automatic separation and recording step. The method is very adaptable, robust and repeatable. It may be used in fully automatic or semiautomatic assemblies. The procedure may be interrupted at several stages. The reagents or reactions products may be preserved until sufficient data has been collected or it is more convenient to continue the process. The method may be used in different scales or formats, i.e. as test tube tests, but also in microliter scale, from which the method may be further miniaturized to be performed in nanoliter scale. The method allows the collection of samples at different time intervals and from different sites and the storage of the collected samples for a final comparative recording with automatic instruments. The thus recorded results enable simultaneous and easy comparison of collected and stored samples.

The present invention allows a simultaneous determination of the relative amounts of a plurality of targets and a nucleotide variation therein from the same sample solution, which may be a cell or tissue lysate and comprises a mixture of unknown polynucleotide sequences including the target sequences, which are to be determined. Naturally, the polynucleotide sequences may be isolated before performing the test, but it is not necessary. In the present invention the nucleotide variations preferably are minor nucleotide variations such as point mutations, inversions, deletions, replacements including one or a few more nucleotides. Often triplets causing single nucleotide polymorphism is a suitable size of the nucleotide variation to be determined. The nucleotide variations can be present in one or more target sequences, one or more of which may represent a gene, in the cell or tissue lysate sample. The term target sequence is accordingly, not to be used as a synonym for gene. According to the present invention, a gene and its nucleotide variations may be represented by several target sequences. It is also typical for the present invention that only one desired nucleotide variation of interest is determined per target. The determination of the absence or presence of a desired nucleotide variation in a target may be quantified and if the targets are from a diploid organism, the homo- or heterozygous state of the nucleotide variation can be determined as well as its level of expression.

The determination of the amounts of a plurality of targets and nucleotide variations is actually carried out by recording detector probes, which have hybridized to the targets. Said detector probes are designed to be complementary to regions, which are flanking the nucleotide variation. In the present invention flanking means that the detector probe is complementary to a sequence that is contiguously adjacent or located in the immediate vicinity of the site, which is expected to carry a nucleotide variation. In other words, when the detector probe has hybridized to the target the nucleotide variation is the next nucleotide on the target. This means that when the detector probes are extended or elongated with one or more nucleotides a contiguous or continuous sequence, an elongated detector probe is formed on the site containing the desired nucleotide variation along the target that is used as a template.

The method of the present invention allows easy comparative assessments of changes, which have taken place in samples obtained at different points of time, e.g. before or after certain treatments, from different sites or from different target organisms. It is possible to detect the presence of possible repair mechanisms by comparing the results obtained from genomic target sequences and expressed sequences. This is useful, especially, when studying life processes and the impact of physical and chemical stimuli applied on the same cells or tissues and allows simultaneous comparative assessment of several biological phenomena, but above all it is useful for diagnosing predisposition to certain diseases related to such nucleotide variations.

The present invention allows a simultaneous quantitative determination of the relative amounts or ratio between a plurality of targets and a nucleotide variation present in a defined site or regions of each of said targets. Especially, if a genomic sequence is expected to have several nucleotide variations, it is recommended that the sequences are fragmented before the hybridization reaction is allowed to take place. The targets, which may be double-stranded genomic DNA, are also rendered single-stranded. Single-stranded mRNA need not be digested, but before the hybridization reaction, particularly genomic DNA sequences are mechanically fragmented, for example by homogenization or sonication or treatment with restriction enzymes or nucleases.

The targets are thereafter provided with means for capturing the targets. This means that before hybridization is carried out, the targets may be provided, preferably in their 3′-terminal end, with affinity-tags, e.g. with biotin, but the affinity-tagging may also be performed with an affinity-tagged probe, a so called capturing probe before or during the hybridization reaction. The capture probe can be specific or unspecific. If a specific capture probe is used, each target to be determined needs its own capture probe. Unspecific capture probes, which can be used for all polyadenylated targets are for example probes comprising poly (dT). Unspecific chemical affinity-tagging known in the art may be used as well.

The method comprises several steps and starts with the addition of a water-based sample solution, e.g. a cell or tissue lysate containing the pretreated targets, which preferably together with a hybridization solution is added to the pool of detector probes comprising a molar excess of more than one water-soluble or solubilizable detector probes and at least one affinity-tagged probe as well as solid supports covered with a counterpart of the affinity-tag.

The detector probes have several defined properties. These properties include that each of the detector probes

(i) is soluble in a water-based sample solution;
(ii) is present in excess as compared to the target;
(iii) is complementary to a defined sequence in the target to be determined, which sequence is located in a site which is directly followed by a nucleotide of the nucleotide variation to be determined;
(iv) has a defined and distinct size allowing a discriminatory separation and recording of each of the detector probes that has hybridized to the defined sequence in the target and the elongated detector probes;
(v) differs in size by at least one nucleotide more than the number of nucleotides to be determined in the nucleotide variation to be determined;
(vi) is tracer-tagged with a detectable label; and
(vii) does not have complementary regions, which allow hybridization with another detector probe in the pool.

The different sizes of the detector probes and the elongated detector probes allow their discriminatory separation and recording of the intensities of the tracer-tags or detectable labels on each of the detector probes. Each of the different detector probes is complementary to a defined site, region, or sequence that is located in a contiguous adjacency to the site of a nucleotide variation in said targets. The nucleotide variation to be determined is usually a variation known to cause a disease or disorder by leading to the absence or presence of a metabolite. Often the homo- or heterozygous state of nucleotide variation is important to know. Because nucleotide variations are known to have different effects depending upon the homo- or heterozygous state and the degree of expression, it is desirable to demonstrate its presence at an early stage in order to take timely measures to prevent its detrimental effects. The detector probes in the pool are preferably provided with tracer-tags, which are detectable labels or markers, such as fluorophors or chromophors, and may be the same for all probes. Alternatively, each of the different detector probes may have their own tracer tags, which allow their discriminatory recording. Preferably, the detector probes are tracer-tagged in their 5′-terminal end, in order to allow undisturbed enzyme-assisted elongation in the 3′-terminal end of the detector probe towards the 5′-terminal end of the target, which acts as a template. The 3′-terminal end of the detector probe, which hybridizes and is complementary to the target, ends at that nucleotide, which precedes the first nucleotide of the site of the nucleotide variation. That site, accordingly, forms a junction between the region that is complementary to the detector probe and the nucleotide variation to be determined.

The hybridization reaction takes place in conditions allowing the formation of stable hybrids on the selected and defined regions of the targets. When the target is polyadenylated, including for example eukaryotic mRNA, the affinity tag is preferably attached to the 3′-terminal end, by hybridization with a poly (dT) probe, which may carry a further affinity tag, such as biotin. The targets are captured through the affinity tag to the counterpart of said affinity tag immobilized on the solid support. Thereby, those detector probes, which have hybridized with a complementary region on one of the targets, are subsequently captured to solid supports, preferably magnetic microbeads, which are covered with a counterpart of the affinity tag, e.g. avidin.

The hybridization reaction and the subsequent or simultaneous binding to the solid support are followed by purification including one or more washings and removal of unbound material. Washed microparticles are transferred to a buffer solution, wherein an enzyme-assisted elongation takes place. If the target is DNA, the enzyme is a DNA polymerase and if the target is RNA, the enzyme is a reverse transcriptase. Further to the enzymes, the buffer solution comprises at least one of the deoxynucleotides (dNTPs) or dideoxynucleotides (ddNTPs), i.e. dATP, dTTP, dCTP, and dGTP or ddATP, ddTTP, ddCTP, and ddGTP in a form, which is applicable in an enzyme-assisted elongation reaction. If the ddNTPs are present in separate vessels, only one nucleotide is added to each probe, and only one nucleotide variation can be determined per vessel and target, but the first nucleotide following probe, whatever it is, can be determined from the different vessels. If the dNTPs are present in different vessels, only that nucleotide variation, wherein the first nucleotide can be elongated is elongated. In the other vessels the probe is not elongated. If the first nucleotide is elongated and is followed by the same type of nucleotide, it can be elongated until a different nucleotide is encountered. In this case different probes on different targets may be differently elongated in different vessels and comparable results may be obtained.

If all different dNTPs are present in the same vessel, the elongation will take place as long as there are dNTPs in the solution. If one or more of the ddNTPs acting as stop codons are added, the elongation can be randomly stopped. The resolution and the length of the detector probes with different sizes, determine how many nucleotides can be detected without disturbing the recording of the results. Therefore, it is convenient to use more than one dNTP, but less than four dNTPs in combination with at least one ddNTP, which act as a stop codon. The dNTPs or ddNTPs may be tracer tagged. Especially, if all four ddNTPs are present in the same vessel, all detector probes are elongated with one nucleotide and the nucleotide variation cannot be distinguished, if they are not tracer-tagged with different detectable labels. If the ddNTPs, as shown in FIG. 2, are provided with different tracer tags, which emit at different wavelengths, they can be discriminatingly recorded. The vessels may be test tubes, microwells, tubular microchannels or reservoirs in a microfluidistic microchip device.

The enzyme-assisted elongation allows simultaneous determination of the amounts of targets and a nucleotide variation present in each of the targets in the sample. Depending on the first nucleotide in the 5′-terminal end of the target immediately following or flanking the first free nucleotide after the hybrid in the 3′-terminal end of the detector probe, said enzyme elongates the detector probes by incorporating one or more nucleotides to the 3′-terminal end of the detector probe in at least one of the nucleotide solutions towards the 5′-terminal end of the target as a template.

The elongation is preferably performed on the solid support, which allows further purification by removal of unbound material, including reagents. However, subsequent purification by washing is not required because the detector probes can be released in the same buffer. The detector probes are released from the solid support by rendering the hybrids single-stranded in a suitable aqueous solution, for example in a denaturating water or buffer solution, which comprises an alkaline sodium or potassium hydroxide solution or formamide and from which solution, the released detector probes may be directly separated and recorded. The affinity-tagged capturing probes attached to the targets or affinity-tagged targets remain attached or immobilized to the solid support and may be separated from the solution containing the detector probes, which are present in the recovered solution. The solid supports with the attached affinity-tagged capturing probes may be removed as waste or they may be recovered for reuse after removal of the affinity-tagged targets. Only those single-stranded detector probes, which have formed a hybrid with the target and thereby have been captured on the solid support, are solubilized by rendering them single-stranded and may be recovered from the solution for separation and recording. The different types of single-stranded detector probes, which preferably are tracer-tagged with detectable labels may be directly and discriminatorily separated and recorded. Even if targets or fragments thereof would be released during the denaturation step and thereby would be present in the solution from which the results are recorded, the targets would not disturb the recording, because they are not tracer-tagged. Further they would have irregular sizes and they would not have defined sizes as the detector probes. If affinity-tagged probes were released simultaneously with the detector probes, they would not disturb the detection, because they are provided with distinguishable sizes and do not have detectable tracer tags.

The final results, it is the determined amounts of targets and the nucleotide variations may be calculated from the results recorded with the stable, well characterized detector probes, prepared from stable DNA or modified DNAs, further using house keeping genes as controls and calibrated recording instruments and standard curves. The data can be analyzed and calculated using commercial available programs and computer software. The detector probes are complementary to defined and selected sites or regions on the targets. The detector probes in the same pool are single-stranded and selected and designed or prepared so that they are not complementary to each other and do not hybridize with each others. Due to the excess of detector probes used in the hybridization reaction, the hybridization reaction is driven to completion in most conditions favouring hybridization and consequently the amounts of detector probes stoichiometrically correspond to the amounts of targets with originally present in the sample. The amounts of detector probes are recorded graphically as spectrograms, electrograms, etc., and the amounts may be calculated from the graphs by measuring the area of the peaks in the graphs with commercially available programs. The method is very robust and repeatable. The results may be calibrated by using suitable controls.

The test kits used in the method of the present invention are characterized by having preprepared pools with mixtures of detector probes, wherein each of the detector probes is defined above. The test kits are provided in package combinations comprising the above defined pools of detector probes, and with further reagents incorporated in the package and with instructions for use including applicable conditions for hybridization and elongation reactions, and target concentrations with appropriate models for diluting the sample solution. For example, if the sample solution is a cell or tissue lysate, it is generally known how many cells should or can be included in a solution and how to dilute it in order to obtain optimal results with the test. The test kit may comprise other commercially available reagents, which allow easy adaptation of the tailor-made tests. The test kits are preferably provided in packaged combinations, including devices containing pools with the desired mixtures of detector probe with instructions for use. It is to be noted that when designing a pool of detector probes for the present method, the selection of probes is of outmost importance.

The pools in the test kits may be provided with affinity-tagged capturing probes and may contain the solid supports covered with the counterpart of the affinity tag. If the targets are mRNA, the affinity-tagged, e.g. biotin-tagged poly (dT) containing capturing probes, which may contain further affinity tags, and are conveniently provided in the pools of detector probes, but they may also be added to the pools separately with the sample solution.

### SHORT DESCRIPTION OF DRAWINGS

FIG. 1 is a schematic illustration of the principles of a method according to the present invention. The target (1), which in this case is RNA, but could be DNA rendered single-stranded, is during a hybridization reaction bound to a tracer-tagged detector probe (2) carrying the tracer tag (2.1) and an affinity-tagged capturing probe (3) carrying an affinity tag (3.1). Only one of the many possible hybrids formed in the hybridization is shown. The target probe complex or hybrid in the box (4) is bound to the surface of a magnetic sphere or bead (5) through the affinity-tagged capturing probe (3). Identical samples are transferred to four vessels, each containing a buffer solution with a reverse transcriptase enzyme (E) and further comprising one of the nucleotides dATP, dTTP, dCTP or dGTP. Depending on the first free nucleotide, in this case the nucleotide G, in the 5′-terminal end of the target (1) in contiguous adjacency to the 3′-terminal AGGTG-end of a probe, the reverse transcriptase enzyme (E) elongates said probe with one or more nucleotides, in this case with the underlined nucleotide C in the buffer solution containing dCTP. In the other solutions containing dATP, dTTP, or dGTP, no elongation takes place.

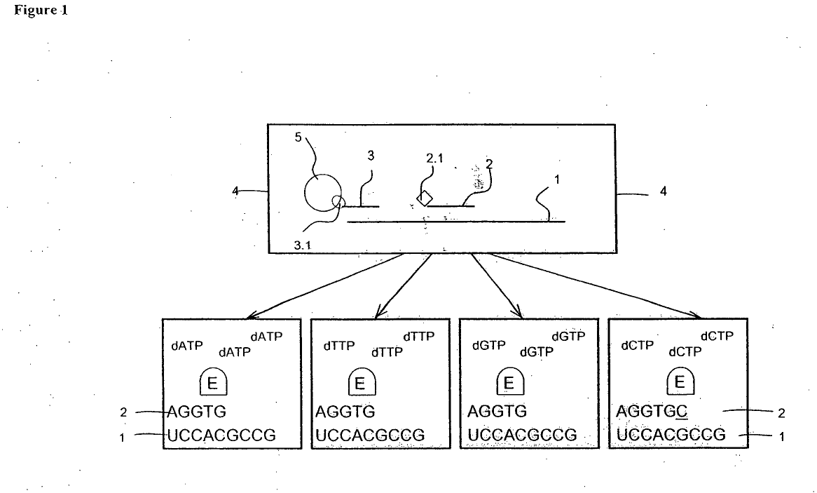

FIG. 2 is a schematic illustration of the principles of another embodiment of the method according to the present invention. Only one of the many possible hybrids formed in the hybridization reaction is shown. The target (1), which in the present case is RNA, but could be single-stranded DNA, is during a hybridization reaction in solution bound to a detector probe (2) and an affinity-tagged capturing probe (3), which carries the affinity tag (3.1). The target-probe-complex or -hybrid in the box (4) is thereafter bound to the surface of a magnetic sphere (5) through the affinity-tagged capture probe (3). The sample is transferred to a buffer solution containing a reverse transcriptase enzyme (E). The solution comprises all four dideoxynucleotides ddATP, ddTTP, ddCTP and ddGTP, which each have a distinct tracer tag indicated as (6.1), (6.2), (6.3), or (6.4) and act as stop codons. Depending on the first free nucleotide, in this case the nucleotide G, flanking the hybrid in the 5′-terminal end of the target (1) in such a manner that the 3′-terminal AGGTG-end of a detector probe may be elongated by the reverse transcriptase enzyme (E), which adds one dideoxynucleotide, ddCTP, to the hybrid. In the detector probe (2) the elongation C is underlined.

FIG. 3 illustrates the results obtained as capillary electrophoresis peaks by using the method of the invention (recording the intensities of the tracer tags). In the experiment three different probes sequences (1, 2 and 3) were used to identify nucleotide variations in a sample containing a lysate from a colon cancer cell-line (COLO205) mixed with a known sequence from E. coli. FIG. 3 shows the results of an elongation reaction performed in the presence of the nucleotide dGTP and reversed transcriptase. For further details see the legend of FIG. 1.

The first probe (SEQ ID NO:3) marked with (1) is complementary to a known E. coli sequence (1-traT), which was in vitro transcribed and added as a positive housekeeping control to the hybridization reaction. The two other probes are complementary to known sequences in the human genome. These probes are GAPDH (SEQ ID NO:1) and PRSS1 (SEQ ID NO:2) and they are marked (2) and (3), respectively.

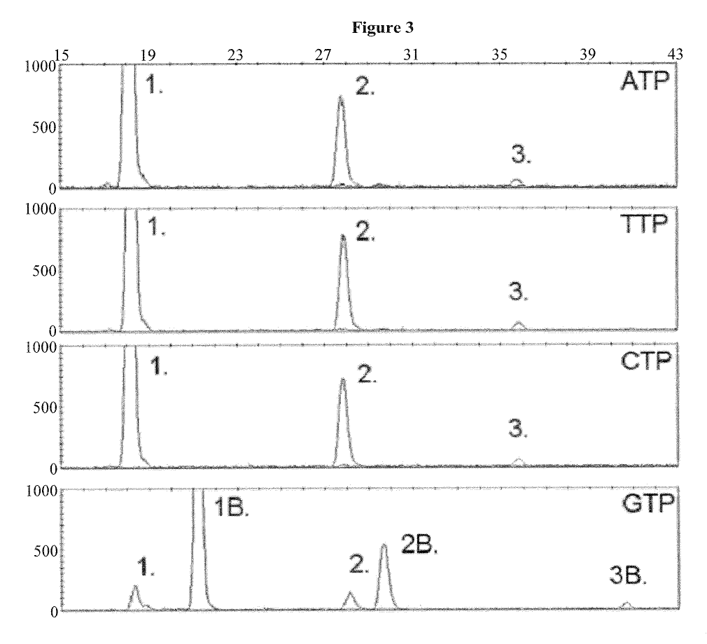

In FIG. 3 peak (1) is from the control probe SEQ ID NO:3, defined above, and peak (1B) is from the probe SEQ ID NO:3 elongated by two dGTP nucleotides. Peak (2) is from the probe SEQ ID NO:1 and peak (2B) is from the probe SEQ ID NO:1 elongated with one dGTP. Peak (3) is from the probe SEQ ID NO:2 and peak (3B) is from the probe SEQ ID NO:2 elongated with three dGTP nucleotides. After the reaction with dGTP, peak (1) and peak (2) are residues of the control probe SEQ ID NO:3 and probe SEQ ID NO:1 that were not elongated by reverse transcriptase enzyme. No residue of probe SEQ ID NO:2 peak (3) was detected in dGTP solution after elongation step. The quantity of the three RNA levels can be calculated based by the area of the peaks (1-3) and (1B-3B) and the identity of the first free nucleotide(s) in continuous adjacency to the 3′-terminal end of the probe was revealed by reaction in which the probes were elongated. If the first nucleotide is not elongated no elongated probe is formed. Since 80-100% of the probe were elongated in the correct reaction solution, it is possible with high accuracy to quantify the level of polynucleotides in a case where the probe can be elongated by two alternative NTPs (Heterozygote, see example 4).

### DETAILED DESCRIPTION OF INVENTION

The present invention is related to a method for simultaneous determination of the amounts of target polynucleotide sequences (targets) and a nucleotide variation in each of the targets, directly from an unpurified water-based sample, e.g. a cell or tissue lysate, but naturally the polynucleotide sequences can be isolated and purified. Nucleotide variations may include a multitude of different genetic variations, such as replacements, inversions or deletions of one or more nucleotides. The method of the invention enables simultaneous determination of the relative amounts of the nucleotide triplets forming a single nucleotide polymorphisms (SNPs), or point mutations present in genomic DNA, but it is particularly useful for determination the amounts of expression products including mRNA and detection of splicing variants. By the present method it is possible to determine whether an individual carrying a certain nucleotide variation in a gene is homozygous or heterozygous for said nucleotide variation. This test can be followed up by determining how these genes are expressed and even some repair mechanisms may be evaluated.

The present invention provides methods and test kits applicable in said methods particularly for determination of expression patterns or transcriptional profiles of target polynucleotide sequences and nucleotide variations therein. Thereby, the present method allows simultaneous, specific and sensitive diagnosing of diseases and hereditary disposition to certain diseases, not only based on samples containing genomic DNA, but also based on samples providing information about expression phenomena and the presence of nucleotide variations in expression products. This provides a totally new dimension in making diagnostic prognosis. Accordingly, an advantage of the methods and test kits of the present invention is that it allows not only the assessment of nucleotide variations in genomic DNA, but also allows assessment of transcriptional profiles or expression patterns and detection of nucleotide variations occurring during expression. These results have a great impact on the diagnostic conclusions made by practitioners in medicine and health care, particularly when making a prognosis of the development of the disease and evaluating the efficacy of a medical treatment.

The present invention is particularly useful for translation of genomics into therapy by providing repeatable quantitative results. The method is convenient not only in genomics, but it can also be applied for expressed genomics and thereby it may provide combined results useful e.g. when evaluating the efficacy of gene therapy. Reliable useful results may be obtained in pathophysiology. The method is useful for determining whether an individual is predisposed to a certain disease, for selecting suitable treatment modalities or for excluding certain treatment modalities, for predicting treatment responses, etc. Today it is known that hereditary causes lie behind a multitude of diseases including vascular diseases, cancer, obesity, etc. and the outbreak of these diseases is not only dependent of genomic factors, but also expression of the genes, and many regulatory factors. Therefore, the present method provides an effective and robust method for translating genomics to therapy by providing quantitative results from a multitude of samples.

The present method allows a multiplexed genotyping, wherein the targets are genomic DNA sequences and the simultaneously determined amounts of the plurality of targets and a nucleotide variation in each target, allow the determination of the ratio between targets and the targets having a nucleotide variation, which ration indicate the homozygous or heterozygous state of each nucleotide variation present in the target sequence to be determined.

The present method also allows a multiplexed analysis of allele specific expression, wherein the targets are expressed RNA sequences and the amounts of the plurality of targets and the nucleotide variation therein allow the determination of the ratio between targets and targets with a nucleotide variation and in addition the level of expression of said target.

The present invention is illustrated by a stepwise description of the pretreatment of targets in the samples, the preparation of tailor-made test kits with pools or mixtures of detector probes with a plurality of defined properties, which are an essential part of the invention. The detector probe may be provided as tailor-made test kits for various purposes. These preparatory steps include preparation of the sample and the targets therein, the selection and construction of detector probes and optional preparation of test kits suitable for different analytical purposes. All analytical steps are first described separately, but in more practical embodiments of the invention, some of the steps may be combined and carried out simultaneously, thereby providing a simplified and very convenient analysis, which is easy to apply in automatic systems. These methods are described in detail in the examples.

### Preparatory Steps

### 1. Preparation of Sample and Target Polynucleotide Sequences

### 1.1 Sample Preparation

In the present invention the amounts of target polynucleotide sequences and the nucleotide variations in said targets, are determined directly from cell or tissue lysates or from genomic DNA or RNA isolated by per se known methods. The isolation of RNA, particularly messenger RNA from the cells is used during appropriate experimental conditions using per se known methods (Sambrook et al., 1989, Molecular cloning, a laboratory manual. 2^{nd} ed. Cold Spring Harbor Laboratory Press, New York, 1989). Alternatively, a crude sample lysate may be used directly. If the target polynucleotide sequences are double-stranded, e.g. genomic DNA, the targets are rendered single-stranded by known methods (Sambrook et al., 1989: Molecular cloning, a laboratory manual. 2^{nd} ed. Cold Spring Harbor Laboratory Press, New York, 1989). Samples comprising genomic DNA may advantageously be somewhat fragmented by mechanical means, including homogenization or sonication of the sample (Sambrook et al., 1989, Molecular cloning, a laboratory manual. 2^{nd} ed. Cold Spring Harbor Laboratory Press, New York, 1989) and the targets are also rendered single-stranded before the hybridization reaction takes place.

The present method is particularly convenient for determining simultaneously the relative amounts of targets and nucleotide variations in a mixture of polynucleotide sequences including the targets to be measured. The method is unique both for determining the amounts of DNA and RNA, but it is particularly useful for determining the amount of nucleotide variations in RNA, particularly messenger RNAs (mRNA). Due to the instability of e.g. mRNA, methods for analyzing RNA typically require a step, wherein the RNA is transformed or converted to the corresponding cDNA. This is totally avoided in the present invention, wherein the mRNA is stabilized by hybridization to the stable detector probes, made of DNA or other modified polynucleotide sequences, because the probes and not the targets are determined. This stabilization takes place in the hybridization step, wherein RNA is hybridized with stabilizing detector probes. Due to the fact that the RNAse and alkali sensitive mRNA targets may be stabilized by the detector probes, RNAse inhibitors or inactivation of RNAses by for example heat, is not required.

### 1.2 Affinity-Tagging Targets

Targets The targets in the present method are the analyte polynucleotide sequences present in the sample, which may comprise but need not comprise a nucleotide variation. The method is particularly useful for determining the amounts of messenger RNA (mRNA) targets, including transcriptional profiles and splicing events. The expression products present at a certain moment or at subsequent time intervals in the cell or tissue of a research object may conveniently be studied. The targets must be modified to carry a suitable affinity tag before the sample is contacted with the pool comprising the defined detector probes, but in a more convenient embodiment of the invention, the targets are affinity-tagged during the hybridization reaction. In that case the hybridization solution comprises a capturing probe, which carries an affinity tag, which preferably is complementary to the 3′-terminal end of the target.

The mRNA targets are conveniently affinity-tagged, or biotinylated using chemical, non-enzymatic processes known in the art. A photoactivated reagent, photobiotin is convenient for this purpose and it is commercially available. As the RNA need not be transcribed to cDNA or otherwise enzymatically modified for labeling, the RNA may be prepared and kept in strong detergents such as SDS. RNAses are inhibited by SDS so it is easy to isolate intact RNA. Usually fragmentation of mRNA in the sample is not a problem, if not too heavy. The size of the RNA fragments will not affect the capturing capacity, but the location of the desired nucleotide variations to be determined should be taken in consideration, when designing the probes. If the target is a sample comprising genomic DNA, the DNA is preferably homogenized or sonicated as discussed above.

Affinity pairs The affinity tag is a substance, which may be used as a label or marker and has a high affinity for another substance Such substances having a high affinity for each others are the affinity tags and the counterparts of said affinity tags, which together form a so called affinity pair. The affinity pairs are substances, which are prone to form strong bonds with each others. Affinity-pairing acts as a means for capturing desired substances. Preferred affinity pairs are for example biotin-avidin or biotin-streptavidin, but other synthetic or non-synthetic affinity pairs or binding substances may be applied as well. Suitable affinity pairs may be found among receptors and ligands, antigens and antibodies as well as among fragments thereof.

In the present invention, the targets must be provided with at least one affinity tag. The affinity-tagging may be performed before or during the hybridization reaction. In order to prevent steric obstacles during hybridization, the affinity tags are preferably the smaller counterparts of the affinity pairs, i.e. biotin, photobiotin, histidine oligomers, haptens, glycans, oligonucleotide sequences, such as oligo(dA), oligo(dT), whereas the preferred bigger counterparts of the affinity pairs, avidin, streptavidin, metal chelates, antibodies, lectins, or nucleotide oligomers, are preferably used to cover the solid supports used in the method.

In the present method it is of outmost importance that the hybridization takes place in solution. Therefore, the targets may be affinity-tagged before the hybridization reaction takes place by a chemical reaction, in which e.g. biotin residues are covalently linked to the polynucleotide sequences or nucleic acid sequences to be studied resulting in modified polynucleotide targets, i.e. biotinylated targets. The affinity tag may also be provided on a capturing probe, which preferably is capable of hybridizing to one of the terminal ends of the targets. This capturing probe may carry additional affinity tags, e.g. biotin. When the targets are mRNA, they need not have any further affinity tag, if the solid support, which is an essential part of the present method solid liquid phase assay, is covered with poly (dT) sequences, which may capture the poly(dA) tail of the mRNA.

When the targets are end-labeled using a capturing probe carrying an affinity tag, the affinity-tagging of the target need not be performed before the hybridization reaction, but may be carried out simultaneously with the hybridization reaction. If desired the affinity-tagged capturing probe may be provided together with the other detector probes in the same pool in a test kit, thereby further simplifying the performance of the method. It is to be noted that the capturing probes cannot disturb the determination, because they are collected on the solid support and remain on the solid support, while the solution containing the soluble detector probes are recovered for separation and recording.

### 2. Preparation of Detector Probes

In the present method the plurality of targets are actually determined by recording stable detector probes that have hybridized to the targets, but due to the stoichiometric formation of target-detector probe-hybrids, the recorded amounts of detector probes actually correspond to the amounts of targets originally present in the sample. When producing pools with mixtures of detector probes the selection of appropriate and useful probes is of outmost importance. Accordingly, the most important step of the present invention, which precedes the analytical steps, is the preparation of detector probes for the test kits. In these preparatory steps, suitable detector probes are selected and designed.

In the present invention the detector probes are soluble in contrast to the systems in which the probes are provided in immobilized form, for example, in the so called micro-array systems. The present invention is a quantitative method and it is important to avoid steric obstacles, which prevent a stoichiometric hybridization reaction. Therefore, the detector probes are provided in soluble or solubilizable form in contrast to the micro-array systems, which apply specific immobilized probes. This means that the probe mixture in the pool may be provided in e.g. lyophilized form or loosely attached to the bottom of a well in microtiter plate. The detector probe is soluble in water-based solution. This means that when a sample solution is added the water-soluble detector probes, they are solved, and they are in solution when the hybridization reaction takes place.

Probes Mixtures of several different detector probes are prepared to provide a pool of detector probes. One or more pools may be used as a test kit. The characteristics of the detector probes are defined in the claims and elsewhere in the description.

Distinct Sizes One prerequisite for the feasibility of the present method is that the different detector probes, which are present as a mixture in the same pool may be discriminatorily separated and recorded. The soluble or solubilizable detector probes are characterized by having distinct sizes, which enable their accurate and discriminatory separation and/or identification for recording by mass spectrometry or capillary electrophoresis. If the specific sequences of the detector probes are of approximately the same size, they may be provided with unspecific regions comprising polynucleotide sequences which enable separation. The detector probes of the present invention are preferably oligonucleotide sequences. In the present invention oligonucleotide sequences mean all probes, which are used in the invention and typically comprise 20 to 200 nucleotides. They have more nucleotides than oligonucleotide sequences normally are considered to have. The detector probes have a size varying from at least 15 nucleotides upwards, preferably from 20 nucleotides upwards, most preferably from at least 25 nucleotides upwards. The upper limit is determined by several factors, including the required resolution, the number of different probes present in a pool, the number of nucleotides which are expected to be incorporated into the elongated probes. Limiting factors for using very long probes are the costs of synthesizing longer probes and the increased risk of undesired interactions and mismatching that could cause them to be mixed with the fragmented targets. The above discussed factors are to be taken in consideration when designing the mixture of detector probes, which are to be present in the same pool. Convenient upper limits for the probe size is about 200 nucleotides, preferably 100 nucleotides, most preferably 50 nucleotides. If for example the nucleotide variation is expected to have one or two nucleotides, the difference in size between the probes in cases wherein the resolution is one nucleotide, must be more than one or two nucleotides, respectively.

Shorter detector probe sequences may be designed by a computer program with for example the following criteria: Probe length range 30-50 nt. Melting temperature range 60-75° C. GC % range 40-60%. Maximal length criteria of a sequence in any part of human genome that is identical to the designed probe sequence should be about 17 nt. Maximal similarity criteria of a sequence in any part of human genome to the probe sequence should be 80%. Minimum size difference between the probes in the pool should be 2 nt. When longer probes are used other criteria must be followed. If both short detector probes and long detector probes are used the criteria must be standardized. Textbooks and laboratory handbooks provide information.

A sufficient resolution of the detector probes is a prerequisite in the method. The resolution in the present method should be so high that it may discriminate between detector probes varying by only two nucleotide. When nucleotide variations are simultaneously analyzed, it is preferable that the detector probes differ in size by more nucleotides than the number of nucleotides, which are expected to be incorporated in the elongation. The results shown in FIG. 3 demonstrate the incorporation of 1-3 nucleotides. In that case the size of the detector probes in the pool should differ by at least four nucleotides, but if only one nucleotide elongation is to be detected, the difference in size between the probes may be smaller. It can be even as small as two nucleotides. Generally, one may say that the difference between the size or number of nucleotides in the probes should at least one nucleotide more than the number of nucleotides which will be determined in the nucleotide variation

Detector Probes Lack Complementary sequences Another prerequisite for selecting detector probes for the present method is that each of the detector probes is complementary to a predetermined and well characterized region on the target. The soluble detector probes for the pools are preferably prepared synthetically based defined regions in the targets. These sites, regions or sequences are selected to be in contiguous adjacency to a possible known nucleotide variation. This means that the detector probe is complementary to a region on the target, which is located in the immediate vicinity of the expected nucleotide variation and which when a target detector probe hybrid is extended by incorporation of one or more nucleotides forms a contiguous or continuous sequence. In other words, the location of the probe on the complementary target enables the formation of a contiguous or continuous elongated sequence or elongated detector probes on the nucleotide variations in the targets. The elongations of the detector probes allow the detection of the presence or absence of one or more nucleotide variations in the flanking target sequences.

Stable DNA probes The International Patent Application WO 02/055734 discloses methods for preparing suitable detector probes from different desired organisms, many of which are already characterized or may or will be characterized in a near future. The detector probes for the present method are prepared synthetically by using oligonucleotide synthesis, PCR-amplification or by recombinant DNA techniques by inserting the desired sequence having a desired number of nucleotides into a plasmid with suitable restriction sites, transforming a suitable microorganism with said plasmid and when the incorporated plasmid has been multiplied releasing the desired probe. For particularly purposes, it is possible to synthesize detector probes with totally randomized sequences. The skilled person today knows a multitude of methods for making suitable oligonucleotide probes.

Probes from uncharacterized genomes Preferably, the detector probes are designed based on known and characterized sequences, but detector probes for the present invention may be designed based on partially characterized or uncharacterized sequences as described in the International patent application WO 2002/055734.

Modified probes If a set of detector probes is prepared synthetically, it is also convenient to prepare modified polynucleotide probes, in which case the sugar phosphate backbone of the nucleotide sequences may be replaced by peptide bonds or made of so called locked nucleoside analogs. Modified polynucleotides are, for example, peptide nucleic acids (PNAs) described e.g. in the International Patent Application WO 96/20212 or locked nucleic acids (LNA), described e.g. in the International Patent Application WO 99/14226. Said modified polynucleotide probes may be applied in the methods and test kits used in the methods of the present invention. They may be copied using genomic DNA or cDNA as templates. Often, these modified probes have improved properties, including improved stability and they may also have the advantage of being more easily tracer-tagged than normal DNA probes.

Applicable probes The method is a useful tool for basic research, but its prime utility is to provide a convenient test for the simultaneous determinations of the presence or absence of certain targets and nucleotide variations therein and thereby concluding whether a subject has a hereditary predisposition to a disease. The method is also useful for concluding whether a certain therapy has had the desired effect. The present invention has been exemplified by using two probes selected and designed based on the human genome. These two detector probes are GAPDH (SEQ ID NO:1) and PRSS1 (SEQ ID NO:2).

Detector probes useful for diagnostics The object of the invention is to provide assays for detecting the presence and absence of nucleotide variation causing inherited diseases. Well known inherited diseases caused by point mutation are sickle cell anemia, β-thalassemias, phenylketonuria, hemophilia α₁-anti-trypsin deficiency (Antonarkis, 1989, New England J Med, 320, 153-163) and cystic fibrosis may be mentioned. An example of polymorphism, which correlates to predisposition to certain diseases, is the three allelic polymorphism of the apolipoprotein E gene (Mahley, 1988, Science, 240, 622-630). Point mutations in micro-organisms might lead to altered pathogenecity or resistance against antibiotics or therapy. A person skilled in the art familiar with the prior art disclosing these genetic variations may easily select suitable probes for detecting these genomic variations.

Tracer tags The detector probes present in a pool have distinct sizes, which allow the recording by mass spectrometry, but in preferred embodiments of the invention the detector probes are provided with tracer tags, i.e. labels or markers, which enable the detection or recording of the probe directly or after contacting with another reagent. All detector probes may be tagged with the same tracer tag, but when preparing the pool of detector probes, it is also possible to provide pools and test kits in which each probe has its own tracer tag, which allows discriminatory recording of each of the detector probes in the pool. In the present invention, the tracer tag or tags are placed in the 5′ terminal end of the detector probe. Such 5′-terminal-end-tagged detector probes are preferred in order to prevent the tracer from disturbing the elongation reactions, which are essential for the quantitative recording of the targets and the nucleotide variations and take place in the 3′-terminal end of the detector probe.

Detector probes are recorded by using tracer tags, which may be recorded based on their electrochemical or magnetic properties, fluorescence, luminescence, radioactivity, infrared absorption, or by enzymatic reactions. Principally, any tracer tags, which are easily recordable by automatic means or instruments and do not disturb hybridization reactions may be used. They may be tracer-tagged with detectable labels during the elongation reaction, but in that case it is to be noted that if the original targets are not provided with tracer tags, they cannot be detected.

Particularly useful tracer tags or labels in fluorescence based technology are the fluorochromes and fluorophors, such as those with fluorescein, rhodamine, pyrene, phycobiliproteins, cyanin dyes or any dyes designed to replace these dyes.

The fluorescein salts include, for example fluorescein isothiocyanate (FITC), 3-O— methylfluorescein phosphate, fluoresceinamine, fluorescein diacetate, fluorescein caproate, fluorescein dilaurate, fluorescein dipropionate, fluorescein di-β-D-glucuronide, fluorescein di-β-D-galactoside, fluorescein mercuric acetate, 5-carboxyfluorescein, tetrachloro-6-carboxy-fluorescine (TET), hexachloro-6-carboxy-fluorescine (HEX), 5-carboxyfluorescein-N-hydroxysuccinimide ester, 5-carboxyfluorescein-X-N-hydroxy-succinimide ester, 5-carboxyfluorescein diacetate or 5-iodoacetamido fluorescein.

The rhodamine salts comprise rhodamine-B-isothiocyanate, sulforhodamine, 5(6)-tetramethylrhodamine isothiocyanate (TRITC), 6-carboxy-rhodamine, 5(6)-aminotetramethylrhodamine (5(6)-amino TMR), 5(6)-carboxytetramethylrhodamine (TAMRA), 5(6)-carboxytetramethylrhodamine-N-hydroxysuccinimide ester, 5(6)-carboxytetramethyl-rhodamine-X-N-hydroxysuccinimide ester, 5(6)-iodoacetamido-tetramethylrhodamine (IATR), x-rhodamine isothiocyanate (XTRITC), or sulfonyl chloride derivative of rhodamine (Texas Red).

The pyrene salts include, for example pyrenesulfonyl chloride or Cascade Blue dye. The cyanin dyes comprise Cy2, Cy3, Cy3.5, Cy5, Cy5.5 or Cy7 dyes. The phycobiliproteins include, for example phycoeryhtrins (PE) such as R-PE, phycocyanins such as C-PC and R-PC-II, or allophycocyanin (APC).

Other potentially useful fluorescent labels include 1,5-IAEDANS (N-(iodoacetaminoethyl)-1-naphthylamine-5-sulfonic acid); methylindoxyl or its salts, such as N-methylindoxyl acetate or N-methylindoxyl myristate; umbelliferyl or its salts or derivatives, such as 4-methylumbelliferyl caprylate, 4-methylumbelliferyl-β-D-galactosidase, MUG (4-methylumbelliferyl-β-D-glucuronide), 4-methylumbelliferyl phosphate or 4-methylumbelliferyl sulfate; NDA (naphthalene dialdehyde); OPD (o-phthaldialdehyde); Quantum dye; propidium iodide; Quinacrine mustard dihydrochloride; SITS (4-acetamido-4′-isothiocyanostilbene-2,2′-disulfonic acid); DIDS (4,4′-diisothiocyanatostilbene-2,2′-disulfonic acid, disodium salt); 5(6)-carboxyeosin or its salts, such as 5(6)-carboxyeosin diacetate or 5(6)-carboxyeosin diacetate-N-hydroxysuccinimide ester; acridine orange hemizinc salt (5(6)-acridinediamine with zinc chloride); NBD chloride (7-chloro-4-nitrobenzo-2-oxa-1,3-diazole); pyridyloxazole; benzoxadiazole; CTC (5-cyano-2,3-ditolyl tetrazolium chloride); ABTS (2,2′-azino-di-3-ethylbenzthiazoline sulfonic acid, diammonium salt); aminonapthalene; dansyl chloride (5-dimethylamino-1-naphthalenesulfonyl chloride); DAPI (4′-6-diamidino-2-phenylinodole dihydrochloride); erythrosin or its salts, such as erythrosin amine or EITC (erythrocin isothiocyanate); ethidium bromide; coumarins such as AMCA (7-amino-4-methylcoumarin-3-acetic acid) or Marina Blue (based on the 6,8-difluoro-7-hydroxycoumarin fluorophore); Bodipy; Oregon Green; maleimide, Lucifer Yellow, porphyrin, PerCP (peridinin chlorophyll protein) or Beljian Red.

Useful fluorescent labels are also the combinations of two or more chromophores or synthetic chromophores. The tandem conjugates include, for example PE-APC, PE-Texas Red, PE-Cy5, PE-Cy5.5, PE-Cy7, APC-Cy5.5, APC-Cy7 or PerCP-Cy5.5. The synthetic chromophore may include, for example an artificial photosynthetic molecule.

The fluorescent labels may be obtained from a variety of commercial sources. A range of Alexa Fluor® dyes (sulfonated coumarin- and rhodamine-based labels) obtained from Molecular Probes has been designed to replace some of the above dyes.

Chromophores and chromogens are substances which interact strongly with visible light, producing different calorimetric end-products in enzymatic reactions. The chromogenic substrates include molecules, such as o-nitrophenol-β-D-galactopyranoside, chlorophenol red β-D-galactopyranoside, 5-bromo-4-chloro-3-indolyl-β-D-galactopyranoside, nitro blue tetrazolium with 5-bromo-4-chloroindolyl phosphate or 3,3′,5,5′-tetramethylbenzidine. Chemiluminescent substrates include acridium esters, adamantyl 1,2-dioxetane aryl phosphates or the 5-substituted analogs, luminol or other cyclic diacylhydrazides.

Other potentially useful tracer tags may be a rare earth metal label including lanthanide, yttrium, or cryptium, or a radioactive label, such as ³²P, ¹⁴C, ³⁵S, ¹²⁵J, or the like, which provides for an adequate signal and has a sufficient half-life.

When the pools of detector probes are made the probes may be labeled directly with a tracer or label by chemical means, such as the polymerase chain reaction (PCR) techniques using labeled or tagged primers, which are specific for the nucleic acid sequence to be amplified. Incorporation of multiple molecules of the label, such as the 3×FITC or 5×FITC tags, to the primer sequence provides higher intensity in the detector stage. Methods for designing the primers and conditions for the PCR amplification of the target sequence are well-known for a skilled person. Labeled primers are obtainable from commercial sources. Suitable nucleotides for direct labeling during PCR are commercially available. Those include the deoxynucleotides, such as dUTP labeled with Fluorescein, Fluorescein-isothiocyanate, Rhodamine, Tetramethylrhodamine, Rhodamine Green, Cyanine-3, Cyanine-5, BODIPY, Coumarin, Texas red, Oregon green or Cascade Blue. Direct incorporation of the dye may result in low-level labeling of the amplified DNA product. Labeling efficiency may be improved by introducing amino allyl dUTP into the PCR product and subsequently chemically coupling the dye to the modified PCR product. Direct labeling may be performed after isolation or synthesis of the DNA construct with methods known in the art, for example by nick-translation.

### 3. Preparation of Test Kits

Pools The test kits of the present invention comprise a pool or pools comprising a mixture of soluble or solubilizable detector probes, which are present in excess as compared to the amount of targets to be determined. The pools may be incorporated in any kind of vessels, which may be totally separate or connected either in a non-fixed or a rigidly fixed manner. In its simplest form, a pool comprises one or more vessels, for example test tubes or bottles, which may be connected together in a non-fixed manner for example in a rack for test tubes. A practical example of pools placed in a vessels connected together in a rigidly fixed manner is provided by the compartments or wells on a microtiter plate. The soluble pools are organized in such a manner that each pool is distinctly identifiable and its content of detector probes is known. Microtiter plates with their compartments or wells are typical, commercially available embodiments allowing convenient and simultaneous handling of many pools. Tailor-made convenient pools with multiple compartments may be developed and constructed and provided with appropriate marks and instructions for use.

A pool is a subset or a library of defined soluble or solubilizable detector probes. Each of the pools in a test kit comprises an optional defined number of detector probes. The number of detector probes in a pool is always more than one. A convenient optional number is approximately 5 or 10 different detector probes. However, the method may be used with as few as two or three detector probes. The upper limit is determined by the resolution. When short detector probes are used, a convenient upper limit for the amount of detector probes in a pool seems to be about 50 to 60, but in order to obtain better resolution the number should be smaller than 50 to 60 detector probes per pool. Not only oligonucleotide probes but also longer polynucleotides may be used as detector probes in the test, but for a pool comprising several probes, the preparation of long polynucleotide probes is not only time-consuming and expensive, but long probes may cause mismatches and ring formation and other problems as discussed above. Therefore, especially for the present invention, wherein nucleotide variations are to be demonstrated, it is preferred to use shorter probes.

Advantageously, the detector probes should be designed so that the detector probes in the same pool do not disturb the hybridization reactions by hybridizing with each others and have different sizes to be discriminatorily recorded. The pools, which comprise a mixture consisting of more than one detector probe, are used to prepare test kits, which are easily applicable in the present method.

As discussed the pools of detector probes used in the test kits are preferably DNA fragments, which preferably are prepared using genomic DNA or RNA sequences as templates. The detector probes may be cDNA copied from characterized, partially characterized or uncharacterized mRNA. The detector probes may be chemically synthesized, they may be made by amplification using PCR reactions and suitable primers and as discussed be conveniently produced synthetically and they may receive their distinct sizes by cleavage with desired restriction enzymes.

The test kits are characterized by having pools comprising a mixture of detector probes, which may be discriminated by their sequences, which are complementary to defined sequences in the targets, their distinct size, tracer tags, etc. In addition to the detector probes, the pools of the test kits may or may not comprise affinity-tagged capturing probes and/or solid supports covered with a counterpart of the affinity tag. The test kits may comprise other ingredients, which are not present in the pools, but are provided as separate reagents, which are commercially available also from other sources. However, the presence of these auxiliary reagents, enable an easy adaptation of the test kits for different tailor-made applications.

As said above the pools in the test kits may comprise affinity-tagged capturing probes, which do not disturb the recording of the detector probes, because they are usually retained on the solid supports after the release of the detector probes and may be reused. Furthermore, they are not provided with tracer tags and are not disturbing recording based on fluorescence, luminescence, etc. Because the sizes of the affinity-tagged capturing probes are different from the sizes of the detector probes, they may be distinguished even if they would be recorded when using mass spectrometry.

In the method of the present invention the target-detector probe-hybrids are captured or attached on a solid support. In the present liquid solid phase hybridization elution method, solid supports are an essential component in the test kit even if they may be provided separately and are commercial available from other sources. The solid supports are preferably magnetic microbeads, which are covered with the counterpart of the affinity tag used. In other words, when the affinity tag is biotin, the counterpart is avidin. Biotin and avidin forms a suitable and preferred affinity pair. The covering of the solid support is achieved by chemical means, sometimes simply the electrostatic affinity between the surface(s) of the solid support and the counterpart of the affinity tag, is sufficient to form a stable binding.

The solid supports are usually micro-beads, latex particles, micro-particles, threads, pegs, sticks, micro-wells, or affinity columns, walls of recesses or reservoirs, which are provided with or covered with the counterpart of the affinity tag. Optionally, the solid support is magnetic or may include means for transferring the particles, e.g. phase separation, electrophoresis or other means, which may be dependent on the presence of the counterpart of the affinity tag.

### Analytical Steps

The present invention is related to a method for a simultaneous determination of the amounts of one or more targets and nucleotide variations, which are present in said targets in a crude cell or tissue cell lysate. The method is carried out by recording detector probes, which are distinguishable and complementary to regions in genomes or genes, which are expected to have a nucleotide variation in its close vicinity. The detector probes are captured on solid supports by hybridization to an affinity-tagged targets. After washing the captured hybrids, an enzyme-assisted elongation is carried out, wherein the captured hybrids are contacted with reverse transcriptase or DNA polymerase, which in presence of deoxynucleotides or dideoxynucleotide enable elongation. After rewashing the detector probes are released and may be discriminatingly separated and recorded. All nucleotides, which may be provided with different distinct tracer tags, may also be recorded separately.

### Step 1—Solution Hybridization

A sample comprising a mixture of targets, which are rendered single-stranded and have been affinity-tagged with a tag like biotin, histidine oligomers, haptens or glycans, oligonucleotide sequences, oligo(dA), or oligo(dT), is added with a suitable hybridization solution to a pool of detector probes. Alternatively, the sample comprising the mixture of targets, which have been rendered single-stranded, is added to a pool of detector probes further comprising the affinity-tagged probes. The hybridization reaction is allowed to take place. The detector probes, which are distinguishable by size and their defined sequences complementary to selected regions on the targets are conveniently provided as tailor made test kits. Thereby, each of the soluble optionally tracer-tagged stable detection probe pools are contacted with an aliquot of the affinity-tagged single-stranded target prereparation and an appropriate hybridization solution. The hybridization is allowed to take place in free solution in a small volume provided by respective pool compartment, e.g. a well on a microtiter plate or a recess or reservoir on a microfluidistic microchip device.

Applicable hybridization conditions are known from prior art. Generally, the solution hybridization takes place under conditions which drive the hybridization towards the formation of hybrids. The use of an excess of probes drives the hybridization to completion. The method is very robust and repeatable. Therefore any hybridization, washing and releasing conditions known from laboratory hand books and text books are applicable. The most preferred conditions vary depending upon the reagents, targets, and may easily be optimized. It is to be noted that for obtaining repeatable results the conditions for comparative assessments should be standardized and not adapted to best suit the reactants.

The hybridization conditions are, for example those as described in Sambrook et al., 2001 (Preparation and Analysis of Eukaryotic Genomic DNA. In: Molecular cloning, a laboratory manual. Cold Spring Harbor Laboratory Press, New York, 3^{rd} ed., pp 6.50-6.64, 2001; Extraction, Purification, and Analysis of mRNA from Eukaryotic Cells. In: Molecular cloning, a laboratory manual. Cold Spring Harbor Laboratory Press, New York, 3^{rd} ed., pp 7.42-7.50, 2001; Working with synthetic oligonucleotide probes. In: Molecular cloning, a laboratory manual. Cold Spring Harbor Laboratory Press, New York, 3^{rd} ed., pp 10.35-10.37, 2001) or other laboratory manuals. Hybridization with a DNA probe, consisting of more than 100-200 nucleotides of target is usually performed at high stringency conditions, i.e. hybridization at a temperature, which is 20-25° C. below the calculated melting temperature Tm of a perfect hybrid.

### Step 2—Separation Step

As described above, target-probe complexes or hybrids are formed during the hybridization reaction. The solid supports described above are required in the method of the present invention for collecting the target probe hybrids formed between tracer-tagged detector probes and affinity-tagged targets. The solid supports, such as microbeads, particularly magnetic microparticles, covered by the larger counterpart of an affinity pair, such as avidin, are added to the hybridization solution or provided in the pools. The captured hybrids may be washed to remove all uncaptured material including detector probes, which have not hybridized to any targets. The solid supports may be magnetic microparticles, e.g latex beads, which assist the capturing and transfer of the solid supports from one solution to another.

By the aid of the affinity-tagged targets, the hybrids are attached to the solid support. Only those detector probes are collected on the solid supports, which are present in the hybrids between probes and targets. The collected target detector probe hybrids may be washed free from all unbound material, cell debris, excess probes including such probes which have not been able to hybridize or find any matching sequences on affinity-tagged target sequences.

Washes are performed in low salt concentration (e.g. 0.1×SSC) and at a temperature, which is 12-20° C. below the Tm. Typical conditions for targets, particularly RNA targets greater than 100-200 nucleotides are presented on pages 7.42-7.50 of Sambrook et al., 1989 (Extraction, Purification, and Analysis of mRNA from Eukaryotic Cells. In: Molecular cloning, a laboratory manual. 3^{rd} ed. Cold Spring Harbor Laboratory Press, New York, 2001). Posthybridization washing of the hybrids should therefore be carried out rapidly so that the probe does not dissociate from its target sequence. Useful hybridization and washing conditions for oligonucleotide probes are presented on pages 10.35-10.41 of Sambrook et al., 2001 (Working with Synthetic Oligonucleotide Probes. In: Molecular cloning, a laboratory manual. 3^{rd} ed. Cold Spring Harbor Laboratory Press, New York, 2001).

### Step 3—The Enzyme-Assisted Elongation of Probes

Alter the hybridization reaction and the washing step, the target-probe-hybrids captured on the solid supports are transferred to a buffer solution for elongation. The elongation buffer solution comprises an enzyme, which may elongate the double-stranded hybrid towards the 5′-terminal end of the target in the presence of one or more deoxynucleotides or dideoxynucleotides. The detector probe is thereby extended with one or more deoxynucleotides or one dideoxynucleotide using the target as a template. The elongation buffer may comprise all four deoxynucleotides, i.e. dATP, dTTP, dCTP and dGTP or all four dideoxynucleotides, i.e. ddATP, ddTTP, ddCTP and ddGTP or a combination thereof. The reagents are commercially available with instructions for use.

In the enzyme-assisted elongation the enzymes may be DNA polymerases, which assist in DNA replication. Said enzymes catalyze the polymerization of deoxyribonucleotides alongside a target strand of DNA, which strand is used as a template. The polymerized molecule is complementary to the template strand. An enzyme used when the targets are RNA is the reverse transcriptase, also known as RNA-dependent DNA polymerase, which is a DNA polymerase enzyme that transcribes single-stranded RNA into double-stranded DNA. These enzymes and buffers used with them are presented e.g. in Sambrook et al. 2001 (In Vitro Amplification of DNA by the Polymerase Chain Reaction. In: Molecular cloning, a laboratory manual. 3^{rd} ed. Cold Spring Harbor Laboratory Press, New York, 2001, pp. 8.18-8.24 and pp. 8.46-8.53). Alternatively the elongation reaction is allowed to take place in conditions recommended by the enzyme manufacturer. Depending on the last free nucleotide directly following after the 3′-terminal end of respective detector probe in the hybrid on the target, the reverse transcriptase elongates or extends the probes by adding one or more nucleotides in at least one of said four solutions.

### Step 4—Washing

The target-probe-hybrids captured on the solid support, with detector probes, which are elongated or not, i.e. the detector probes have their original size or are elongated by one or more nucleotides, may be washed to remove unbound nucleotides, the enzyme and other unbound materials, but purification is not necessary and therefore it is recommended to go directly to the release step.

Step 5—Releasing the Detector Probes from the Hybrids

After the washing the detector probes with or without extensions are released by eluting the hybrids on the solid support with a solution, which breaks the hybrid, i.e. renders the target and probe single-stranded. Such annealing conditions are provided by formamide or alkaline solutions, e.g. sodium or potassium hydroxide. The solid support with the affinity-tagged probe attached to it may be mechanically separated from solution, which thereafter contains only detector probes. If necessary the single-stranded DNA may be precipitated and washed. The elution of detector probes from target sequences is performed in conditions that favour separation of hybrids resulting in single-stranded nucleic acids. Such conditions may be achieved e.g. by using formamide, buffers with very low salt concentration, alkaline water or buffers. The separation of the detector probes from the targets may be enhanced by using elevated temperatures (30° C. or higher). Preferably the buffers should be such that they may be used in the subsequent capillary electrophoresis and detection.

### Step 6—Recording of Results

The detector probes rendered single-stranded are added to an electrophoresis buffer. Preferably, such conditions should be used that electrophoresis may be carried out directly with the buffers previously used and the different detector probes recorded simultaneously. The detector probes of DNA with or without elongations are eluted from the hybrids and subsequently separated by capillary or gel electrophoresis based on their sizes and thereafter recorded.

### Step 7—Recorded Results and Calculation of the Amounts of Detector Probes

Subsequently, the amounts of the detector probes may be calculated from the graphs by extrapolating the area of the peaks on the graph and calibrating the results with appropriate controls. If the detector probes are tracer-tagged, they may be recorded using different instruments recording the signals of the appropriate tracer tags, e.g. the fluorescent labels, which may be the same or different. Commercial systems are available for recording and calculating the results.

### Step 8—Interpretation of Recorded Results and Calculation of the Amounts of Targets

Because the recorded detector probes were present in excess, the hybridization reaction was driven to completion. Consequently, it may be assumed that those detector probes, which were captured to the solid supports, had hybridized to all complementary target regions present in the sample. Therefore, the amounts of targets and the nucleotide variations correspond to the amount of measured detector probes and their elongations.

The invention is illustrated by the following examples.

### EXAMPLE 1

### Identification of Single Nucleotides in Expressed RNAs

The example demonstrates a quantitative determination of three mRNA target molecules from crude lysates of colon cancer cell line COLO205 with simultaneous identification of one or more nucleotides following each of the target-detector probe-hybrids. Two of the mRNA target molecules were human genes PRSS1 coding for serine protease and GAPDH coding for glyceraldehyde-3-phosphate dehydrogenase. The third mRNA target was an in vitro transcribed Escherichia coli traT gene that was used as a positive control.

### 1. Preparative Steps

### Preparing Probe Pools

Probe sequences were designed for two known human genes present in the used colon cancer cell line

PRSS1 protease, serine, 1 (trypsin 1), NM_{—}002769.2 and
GAPDH glyceraldehyde-3-phosphate dehydrogenase NM_{—}002046.3.
A control probe identifying the E. coli traT RNA sequence was designed.

The probe sequences were designed by a computer program with the following criteria: Probe length range 30-50 nt. Melting temperature range 60-75° C. GC % range 40-60%. Maximal length criteria of a sequence in any part of human genome that is identical to the designed probe sequence was 17 nt. Maximal similarity criteria of a sequence in any part of human genome to the probe sequence was 80%. Minimum size difference between the probes in the pool was 2 nt. Using these criteria the following probes were designed.

The probe sequence (SEQ ID NO: 1)
5′ AGCACAGGGTACTTTATTGATGGTACATGACAAGGT 3′

having 36 nucleotides was used for detecting GAPDH glyceraldehyde-3-phosphate dehydrogenase, NM_{—}002046.3 and its nucleotide variations.

The probe sequence (SEQ ID NO: 2)
5′ CCTCAAGGAAGCCCACACAGAACATGTTGYTGGTAATCTTTCCA 3′

having 44 nucleotides was used for detecting PRSS1 protease serine, 1 (trypsin 1), NM_{—}002769.2 and nucleotide variations therein.

The probe sequence (SEQ ID NO: 3)
5′ ACCACACGGGTCTGGTATTTATGCT 3′

having 25 nucleotides is used for detecting in vitro transcribed Escherichia coli traT mRNA, EMBL:ECPTRAT, accession X14566 and nucleotide variations therein.

GAPDH and PRSS1 probes were synthesised by Metabion and traT probe by Applied Biosystems. The probes were combined to a one pool.

Preparation of E. coli mRNA Used as Positive Control

E. coli traT (EMBL:ECPTRAT, accession X14566) RNA was used as a positive control in the hybridisations. The PCR primers (SEQ ID NO:4) and (SEQ ID NO: 5) 5′ CTAATACGACTCACTATAGGGAGAATGAAAAAATTGATGATGGT and 5′ TTTTTTTTTTTTTTTTTTTTTTTTT-CAGAGTGCGATTGATTTGGC (Metabion, Martinsried, Germany) were used to synthesise, from E. coli DNA, a template containing the T7 promoter sequence and a 25 nt long T tail. The traT RNA was transcribed in vitro by T7-RNA polymerase from this template, using the MEGAscript transcription kit (Ambion, Austin, Tex.) as recommended by the manufacturer. The synthesized traT RNA was quantified by Agilent Bioanalyser and RiboGreen RNA quantification kit (Molecular Probes, Leiden, The Netherlands) as recommended by the manufacturer.

### Preparing Cell Lysates

Human colon cancer cell line COLO205 was cultured on 96-well plates. Approximately 10×10⁴ cells were added to 12 wells of a 96-well plate and cultured for 24 h in 100 μl of RPMI 1640 growth medium containing 10% FBS, 100 U/ml penicillin, 100 μg/ml streptomycin and 1% glutamine at 37° C. in 8% CO₂. After 24 h cells were lysed with 100 μl of lysis buffer: 0.5% SDS (sodium dodecylsulphate) in 1×TE (10 mM Tris-HCl, 1 mM EDTA, pH 7.5). Cells treated with lysis buffer were passed through a needle with a syringe.

### Hybridisation

100 μl cell lysates were transferred to hybridisation buffer containing 4 pmol affinity-tagged biotinylated oligo(dT) affinity probe (Promega), 1 pmol of the 6-carboxy fluorescein (6-FAM) labelled probes GAPDH and PRSS1 and one 2,7′,8′-benzo-5′-fluoro-2′,4,7-trichloro-5-carboxy-fluorescein (NED) labelled traT probe, 5×SSC (750 mM sodium chloride, 75 mM sodium citrate), 0.2% SDS, 1×Denhardt solution (0.02% Ficoll, 0.02% polyvinyl pyrrolidone, 0.02% BSA), and 1.5 fmol of in vitro transcribed Escherichia coli traT mRNA. The hybridizations were carried out in 96-well PCR plates (ABgene, Epsom, UK) at 60° C. for 30 min with shaking at 650 rpm (Thermomixer Comfort, Eppendorf, Hamburg, Germany)

### Affinity Capture, Probe Elongation, Washing and Elution

The steps following hybridization, including affinity capture, probe elongation, washing and elution, were automated with a magnetic bead particle processor KingFisher 96 (Thermo Electron, Vantaa, Finland) in 96-well plates at room temperature as follows:

1) affinity capture of hybridized RNA targets to 50 μg of streptavidin-coated MyOne DynaBeads (Dynal, Oslo, Norway) for 30 min;
2) washing of the beads two times for 1.5 min in 150 μl of 0.1×SSC, 0.1% SDS;
3) incubation of the beads in four alternative solutions containing 2 mM Mg₂Cl, 2.4 U/μl M-MuLV RNaseH⁻ transcriptase (F-572L, Finnzymes) and 0.4 mM of one of the dNTPs: dATP, dTTP, dCTP or dGTP in M-MuLV reaction buffer (F-577B, Finnzymes) for 30 min in 37° C. in total volume of 50 μl;
4) washing of the beads two times for 1.5 min in 150 μl of 0.1×SSC, 0.1% SDS; and
5) elution of probes with 10 μl of formamide (Applied Biosystems) for 20 min at 37° C., which rendered the hybrid single-stranded.

The eluates were analyzed by capillary electrophoresis with an ABI PRISM 3100 Genetic Analyzer (Applied Biosystems, Foster City, Calif.). To calibrate the separation of the detector probes by size, GeneScan-120LIZ size standard (Applied Biosystems) was added to each sample. The identity of the probes was determined by the migration speed and the quantity by the peak area.

The results were as shown in FIG. 3.

### EXAMPLE 2

### Identification of Nucleotide Variations in a Single Reaction Vessel

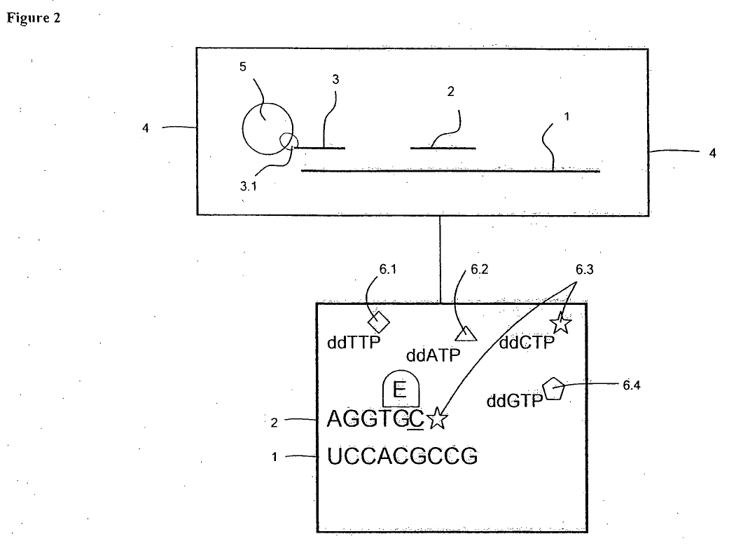

The preparation of targets and probes are as described in Example 1, but the sample containing one or more target polynucleotide sequences which have been affinity-tagged, hybridized, captured on a solid support and washed are transferred to a reverse transcriptase-containing buffer solution, which further comprises all of the components ddATP, ddTTP, ddCTP and ddGTP each labeled with a distinct tracer tag (FIG. 2). Depending on the free nucleotide following directly after the 3′-terminal end of the probes on the 5′-terminal end of the target, said reverse transcriptase elongates one or more of the probes with one nucleotide in said solution. When a ddNTP is incorporated, the extension reaction stops because a ddNTP contains a H-atom on the 3rd carbon atom (dNTPs contain a OH-atom on that position). In this case the probe complementary to polynucleotide sequence used in the hybridisation is not necessarily tracer-tagged, but the tracer is incorporated during probe extension by reverse transcriptase. After elution the elongated probes are quantified preferably by capillary electrophoresis and the identity of the nucleotide following the 3′-terminal end of the probes is revealed by the type of tracer tag. The results are demonstrated and calculated as described in Example 1.

### EXAMPLE 3

### Use of the Method to Quantify Expression of Cystic Fibrosis Transmembrane Regulator Gene (CFTR) and Identification of Cystic Fibrosis (CF) Causing Single Nucleotide Polymorphisms (SNPs) Therein

Cystic fibrosis (CF) is a common lethal genetic disorder, which is inherited in an autosomal recessive manner. Individuals who have a homozygote or compound heterozygote of the pathogenic CFTR mutations suffer from CF, the disease phenotype of CF varies from severe to mild pulmonary diseases with varying degree of pancreatic insufficiency (Lee et al., Mutation research (2005), 573, 195-204). Currently, more than 1000 mutations of CFTR have been registered. Several mutations of the CFTR gene, such as F508del (most common), 394delTT, G542X, N1303 are associated with the severe CF phenotypes and display a high disease penetrance.

Using the method described in the present invention, we are going to measure the allele specific expression of CFTR gene in samples collected e.g. from different types of human tissues with identification of different CF related nucleotide variations therein.

### Preparative Steps

### Preparing Cell Lysates

First the tissue samples are disrupted into small particle sizes e.g. by homogenization. The resulting sample material with small particles is lysed similarly to colon cancer cell line samples in example 1.

### Preparing a Probe Pool

Five or more oligonucleotide probes will be designed that bind to such locations of the CFTR mRNA that they may be used in identification of the five or more different CF disease related nucleotide variations or mutations (e.g. F508del, 1540A/G, 394delTT, G542X, N1303K). The probe sequences to be used in identification of the corresponding CFTR gene sequence variations/mutations and organized into one pool could be the following:

F508del
The probe (SEQ ID NO:6)
5′-GTATCTATATTCATCATAGGAAACACCAA
having 29 nucleotides is used for detection of
mutation F508del, i.e. a deletion of 3 bp between
1652 and 1655.
Target sequences:
Wild type sequence (SEQ ID NO:7) is
TCATCTTTGGTGTT
and the CF causing F508del mutation is
TCA...TTGGTGTT,
wherein...indicates the site of the 3 deleted
nucleotides of (SEQ ID NO:8)
1540A/G,
The probe SEQ ID NO:9 is a probe for detection of
1540A/G nucleotide variation and identifies
methionine/valine polymorphism at codon 470
(M470/V470) and has the sequence
5′-TACCCTCTGAAGGCTCCAGTTCTCCCATAATCA.
Target sequences:
1540A (Methionine at codon 470) is SEQ ID NO:10
TAATGATGATTA
TAATGGTGATTA
SEQ ID NO:11 is 1540G (Valine at codon 470).
394delTT
The probe is SEQ ID NO 12
5′-GAGAGGCTGTACTGCTTTGGTGACTTCCCCTAAATAT
The probe is used for detection of 394delTT,
deletion of two T bases at sequence position 394.
Target sequences:
Wild type (SEQ ID NO:13) is
TCTTTTTATATTTAGGGGAAGTCACC
and
TCTTT..ATATTTAGGGGAAGTCACC
is the sequence (SEQ ID NO:14) with two deleted T
bases, the 394delTT mutation causing CF, wherein
the two dots .. indicate the two deleted T bases.
G542X
The probe is (SEQ ID NO:15)
5′ ATTCTTGCTCGTTGACCTCCACTCAGTGTGATTCCACCTTCTC
which is used for detection of G542X nucleotide
variation.
Target sequences:
wild type is SEQ ID NO:16
TTCTTGGAGAAGGTGGA
and
TTCTTTGAGAAGGTGGA
is SEQ ID NO:17, which contains the CF causing
G542X mutation.
N1303K
Probe is SEQ ID NO:18
5′ GCAACTTTCCATATTTCTTGATCACTCCACTGTTCATAGGGATCCAA
which is used for detection of N1303K.
Target sequences:
Wild type is (SEQ ID NO:19)
GAAAAAACTTGGATC
and
GAAAAAAGTTGGATC
is (SEQ ID NO:20), which contains the CF causing
N1303K mutation.

The length difference of the probes allows their identification in one pool by using capillary electrophoresis of mass spectrometry.

### Hybridisation

The hybridisation reaction will be carried out as described in example 1 using the above probes targeted for detection of said CF causing nucleotide variations with or without fluorescence label.

### Affinity Capture, Probe Elongation, Washing and Elution

Affinity capture, probe elongation, washing, elution will be carried out similarly as described in Example 1. The detection of the probes organised in one pool will be carried out using a capillary electrophoresis or mass spectrometry.

### Results:

For each probe there are three potential results.

1. Wild homozygote, i.e. the sample contains only CFTR mRNA with wild type sequence of the studied variation, which may be quantified by the amount of the measured elongated probe.
2. Mutated homozygote, i.e. the sample contains only CFTR mRNA with mutated sequence of the studied variation, which may be quantified by the amount of the measured elongated probe.
3. Heterozygote, i.e. the sample contains both wild type and mutated CFTR mRNA sequences, which ratio may be quantified by the amount of the elongated probes. This may be used in diagnostics of the CF disease. The expression ratio may also be used in prediction of the severity of the disease. Furthermore, tissue specific expression of different alleles may be compared between samples collected from different tissues. The specific result for each target nucleotide variation is described below in detail.

### F508del

Wild homozygote: The probe is elongated by one dATP.
Mutated homozygote for F508del: The probe is elongated by one dTTP
Heterozygote: The probe is elongated either with one dATP or one dTTP. The ratio of these two differently elongated probes reveals the relative expression of the two alleles (wild and mutated sequences)

### 1540A/G

Homozygote for VV470 (1540A): The probe sequence is elongated by two dCTPs
Homozygote for MM470 (1540G): The probe sequence is elongated by one dTTP
Heterozygote for VM470 (1540A/G): The probe sequence is elongated either by two dCTPs or by one dTTP. The ratio of these two differently elongated probes reveals the relative expression of the two alleles (wild and mutated sequences).

V470 polymorphism is not a disease causing variation, but V470 associated with other mild CFTR variations may become disease causing.

394delTT
Wild homozygote: The probe is elongated by five dTTPs
Homozygote for 394TT: The probe is elongated by three dTTP
Heterozygote: The probe is elongated either by three dTTPs or five dTTPs. The ratio of these two differently elongated probes reveals the relative expression of the two alleles (wild and mutated sequences).

### G542X

Wild homozygote: The probe is elongated by one dCTP
Homozygote for G542X: The probe is elongated by three dATPs
Heterozygote: The probe is elongated either by three dATPs or one dCTP. The ratio of these two differently elongated probes reveals the relative expression of the two alleles (wild and mutated sequences).

### N1303K

Wild homozygote: The probe is elongated by one dGTP
Homozygote for N1303K: The probe is elongated by one dCTP
Heterozygote: The probe is elongated either by one dCTP or one dGTP. The ratio of these two differently elongated probes reveals the relative expression of the two alleles (wild and mutated sequences).

1. A method for simultaneous determining from a sample solution comprising a plurality of polynucleotide sequences, the amounts of a plurality of target polynucleotide sequences (targets) and a nucleotide variation present in each of said targets by measuring the amount of oligonucleotide sequences (detector probes) that have hybridized to said targets and the amount of detector probes that have been elongated, wherein the nucleotide variation comprises at least one nucleotide to be determined and the method of determination comprises the steps of:
(a) preparing one or more detector probe pools, each pool comprising a mixture of at least two different single-stranded detector probes, wherein each of the detector probes in the mixture
(i) is soluble in a water-based sample solution;
(ii) is present in excess as compared to the target;
(iii) is complementary to a defined sequence in the target to be determined, which sequence is located in a site which is directly followed by a nucleotide of the nucleotide variation to be determined;
(iv) has a defined and distinct size allowing a discriminatory separation and recording of each of the detector probes that has hybridized to the defined sequence in the target and the potentially elongated detector probes;
(v) differs in size by at least one nucleotide more than the nucleotides to be determined in the nucleotide variation to be determined;
(vi) is tracer-tagged with a detectable label; and
(b) contacting the pool comprising the mixture of detector probes with the sample solution comprising a plurality of polynucleotide sequences including the targets, which have been rendered single-stranded;
(c) allowing a hybridization reaction to take place between the detector probes and the targets, which are affinity-tagged before or during the hybridization reaction by providing hybridization conditions favouring formation of affinity-tagged target-detector probe-hybrids;
(d) capturing the affinity-tagged polynucleotide sequences including the target-detector probe-hybrids on a solid support covered with a counterpart of the affinity tag on the target;
(e) purifying the solid support by removing unbound material and washing said solid support;
(t) performing an enzyme-assisted elongation reaction by contacting the solid support comprising the target-detector probe-hybrids with a buffer solution comprising an enzyme, which in the presence of at least one deoxynucleotide or at least one dideoxynucleotide is capable of elongating the 3′-terminal end of the detector probe using the target as a template with at least one deoxynucleotide or with one dideoxynucleotide;
(g) releasing the detector probes including the elongated detector probes by rendering the target-detector probe-hybrids single-stranded;
(h) determining the amounts of the plurality of targets polynucleotide sequences and the nucleotide variations therein by calculating the amount of the released detector probes including the elongated detector probes thereof by separating said detector probes by size from each other using capillary or gel electrophoresis and recording as graphs the intensities of the detector probes tracer-tagged with detectable labels using calibrated automatic or semiautomatic recording instrument and standardizing controls, wherein each of the peaks in the graph corresponds to the amount of a detector probe or an elongated detector probe derived tiom said detector probe, wherein the amount of each detector probe and each of the elongated detector probes taken together corresponds to the total amount of a complementary target that has hybridized to said detector probe and the amount of each of the elongated detector probes corresponds to the amount of respective nucleotide variation present in said target.

2. The method according to claim 1, wherein the enzyme-assisted elongation is performed in separate buffer solutions, wherein each solution comprises only one of the four dideoxynucleotides or one of the four deoxynucleotides.

3. The method according to claim 1, wherein when the targets are RNA, the enzyme is a reverse transcriptase.

4. The method according to claim 1, wherein when the targets are DNA, the enzyme is a DNA polymerase.

5. The method according to claim 1, wherein the targets are affinity-tagged with an affinity-tagged capturing probe before or during the hybridization reaction.

6. The method according to claim 1, wherein when the targets are polyadenylated, the targets are affinity-tagged with a capturing probe, which is a poly (dT) sequence acting as an affinity tag or a poly (dT) sequence with a further affinity tag.

7. The method according to claim 1, wherein the detector probes are DNA fragments, synthetic or modified oligonucleotide sequences.

8. The method according to claim 1, wherein the solid supports are added to the pools before, during or after the hybridization reaction.

9. The method according to claim 1, wherein the detectable label is detectable based on fluorescence, luminescence, infrared absorption, radioactivity or an enzymatic reaction.

10. The method according to claim 1, wherein detectable label is a fluorophor or a chromophor.

11. The method according to claim 1, wherein the affinity tag and its counterpart form an affinity pair selected from the group consisting of biotin and avidin, biotin and streptavidin, a histidine oligomer and a metal chelate, a hapten and an antibody, a receptor and a ligand, and a glycan and a lectin.

12. The method according to claim 1 for performing multiplexed genotyping, wherein the targets are genomic DNA sequences and the simultaneously determined amounts of the plurality of targets and the nucleotide variation in said target allow the determination of the ratio between the target and targets having a nucleotide variation and thereby the homozygous or heterozygous state of each nucleotide variation present in the target to be determined.

13. The method according to claim 1 for performing a multiplexed analysis of allele specific expression, wherein the targets are expressed RNA sequences and the amounts of the plurality of targets and the nucleotide variation therein allow the determination of the ratio between a target and a target with a nucleotide variation and the level of expression of said target.

14. The method according to claim 1, wherein the determination is performed on a test kit, wherein the test kit comprises one or more detector probe pools, which are placed in separate or joined vessels and each of which detector probe pools comprises a mixture of at least two different single-stranded detector probes, wherein each of the detector probes in the mixture,
(i) is soluble in a water-based sample solution;
(ii) is present in excess as compared to the target;
(iii) is complementary to a defined sequence in the target to be determined, which sequence is located in a site, which is directly followed by a nucleotide of the nucleotide variation to be determined;
(iv) has a defined and distinct size allowing a discriminatory separation and recording of each of the detector probes that has hybridized to the defined sequence in the target and is potentially elongated;
(v) differs in size by at least one nucleotide more than the nucleotides to be determined in the nucleotide variation to be determined; and
(vi) is tracer-tagged with a detectable label;
in a packaged combination with further reagents incorporated in the package and with instructions for use including applicable conditions for hybridization and elongation reactions, and target concentrations with appropriate models for diluting the sample solution.

15. The method according to claim 14, wherein the test kit further comprises an affinity-tagged capturing probe placed in the pool or separately in the package combination.

16. The method according to claim 14, wherein the test kit further comprise a solid support covered with the counterpart of the affinity tag placed in the pool or separate in the packaged combination.

17. The method according to claim 14, wherein the test kit further comprise in the package combination, enzymes, dideoxynucleotides, deoxynucleotides and auxiliary buffers and solutions.
